(19) United States
(12) Patent Application Publication
(10) Pub. No.: US 2013/0113424 A1
(43) Pub. Date: May 9, 2013

(54) Temperature-controlled external battery charger and standardized, manually-changable modular battery system for electric-powered vehicles and craft

(71) Applicant: Michael Lynn Froelich, Austin, TX (US)

(72) Inventor: Michael Lynn Froelich, Austin, TX (US)

(21) Appl. No.: 13/573,483

(22) Filed: Sep. 18, 2012

Related U.S. Application Data
(60) Provisional application No. 61/540,556, filed on Sep. 29, 2011.

(51) Int. Cl. H02J 7/00

(52) U.S. Cl. CPC H02J 7/00
USPC 320/109

(57) ABSTRACT

The present invention relates to a temperature-controlled external battery charger and standardized, hand-changable battery modules for electric-powered vehicles such as automobiles, trucks, buses, boats, ships, air and spacecraft. Charging a vehicle's batteries in an external charger with a controlled temperature solves the problems of current designs, in which batteries degrade due to charging-induced heating, and must be either charged in the vehicle or must be changed by prohibitively-expensive changing robots. The present invention makes it possible to change vehicle batteries by hand, thereby permitting the vehicle to operate for very long durations by simply changing battery modules. By permitting the batteries to be charged outside of the vehicle the vehicle needs no on-board power source for charging, and need not sit idle for periods of time while its batteries are charging.

### FIELD OF THE INVENTION

The present invention relates to vehicles or craft of any kind which are powered by a power source with definable dimenstion in which that power source depletes and requires replacement. In particular, and for the one application, for vehicles powered by electric batteries.

### BACKGROUND

Current all-electric vehicles are not competitive with their traditional fuel-burning internal combustion engine-powered counterparts becasuse currently used batteries cannot be removed and quickly changed with newly charged ones. Instead, current all-electric vehicles must cease operation for an extended time while their batteries are charged by means of an electric tether connecting them to an exterior charger.

Hybrid vehicles charge stationary batteries within the vehicle by means of an on-board internal combustion engine powering a charger. However this system is more expensive than an all-electric vehicle because it contains two power sources instead of only one. The additional of the internal combustion/fuel-burning power source to charge the vehicle's batteries drastically increases the cost and complexity of the vehicle.

Systems for vehicle operatorss to swap batteries with other operators are not workable because 1. no one has yet proposed a standardized hand-changable battery module, and 2. the batteries proposed for swapping would be different ages and degradation and therefore different values.

As well, systems for vehicle operators to change leased batteries exist, however they do not possess hand-changable batteries or battery modules, and therefore require expensive robots and bays to change the very large and heavy batteries. These systems are so expensive that no one has been able to provide them. There is no prospect that they could be affordably adopted by vendors in a disperse enough manner so that all-electric vehicle operators can rely on finding charged batteries where they need them when travelling.

The prime advantage and purpose of this invention is to provide two means of vehicle operation which will permit all electric vehicles using this invention to out-compete fuel-burning vehicles in cost, reliability and range convenience. The first means of vehicle operation is the use of this invention in fleet vehicles which rely on the common charging base or bases. In this means a fleet of vehicles such as buses, taxis, delivery trucks or law enforcement units can be operated continuously merely by returning to a re-charging base where their batteries are charged with a different set. The vehicles in such a fleet would likely be obtained from a manufacturer providing at least two sets of batteries contained within Battery Modules for each vehicle provided.

Once such fleets of vehicles have become common in a broad geographic region or nation it would be practical for existing vendors of vehicle fuels to begin also stationing chargers for standardized Battery Modules. With the proliferation of such vendors in a region or country, operators of vehicles using this invention may enjoy ranges comparable to that possessed by their traditional fuel-powered combustion engine counterparts.

### SUMMARY OF THE INVENTION

The purpose of the invention is to overcome entirely the aspects of current all-electric battery-powered vehicles which make them undesirable relative to their fuel-powered combustion engine counterparts.

All-electric vehicles already possess some major advantages over internal-combustion engine vehicles. These advantages are: the much simpler, lighter and more reliable design of electric vs. internal combustion engines, the much simpler requirements electric motor powered vehicles possess for transmission and torque conversion requirements, the superior acceleration, efficiency, and torque afforded by electric motors vs. internal combustion engines.

However these substantial advantages are offset by the lack of an acceptable operation distance, and consequent duration, required by operators of fleet vehicles. As well these substantial advantages are currently offset by the lack of a workable battery changing system so vehicle operators may travel significant distances from place to place within or between regions.

In order to make all-electric vehicles cost competitive with fuel-burning vehicles the cost of batteries must be offset with the other economies. For this reason extending battery life by means of a Temperature-Controlled External Charger is provided. Additionally, because all-electric vehicles do not possess complex combustion engines which wear out, and only possess very simple transmissions if any at all, the longevity of the all-electric vehicles using this invention may be much longer than their fuel-burning counterparts.

The prospect of a vehicle which need only be replaced after operation of 500,000 or even one million miles would offset the replacement costs of fuel-burning vehicles, which possess transmissions and motors which must be re-built or replaced after perhaps 200,000 miles of operation [although most fleets do not even operate their vehicles to that extent].

The componants of the invention work in this way. When the Battery Modules are placed into the Temperature-Controlled Exterior Battery Charger the individual batteries [or battery] within the Battery Module is charged with minimum thermal degradation to the individual batteries [or battery]. When the individual batteries [or battery] are charged the Battery Module is removed by hand from the Temperature-Controlled Exterior Battery Charger and placed into the Vehicle Battery Module Housing inside the vehicle. When the Vehicle Receiving and Battery Module Couplings mate the vehicle is powered and may be operated until the charge on the individual batteries [or battery] is near depletion. Then the Battery Modules are removed from the Vehicle Battery Module Housing by hand and placed into the Temperature-Controlled Exterior Battery Charger. A different set of Battery Modules are removed from the Temperature-Controlled Exterior Battery Charger and placed into the Vehicle Battery Module Housing so the vehicle can continue operation.

Construction of the invention is as follows. Fabricate the Temperature-Controlled External Battery Charger by building a body with a cavity, or cavities, into which the Battery Modules can be seated. Place within the Temperature-Controlled External Battery Charger a mechanical or electrical cooling device to chill the Battery Modules while seated in the cavity, or cavities. Place an electrical coupling in the Temperature-Controlled External Battery Charger so it may mate with the Battery Module Coupling so that the individual batteries [or battery] in the Battery Modules may receive an electrical current from an electrial charger within the Temperature-Controlled Exterior Battery Charger and thus be re-charged. Construct the Battery Modules out of strong, lightweight, rigid materials according to these dimensions: the optimum weight of the Battery Module is no more than 26 pounds, and no larger in dimension than 31 cm by 17 cm by 10 cm, not including the handle. Then place within the Battery Module the battery, or individual batteries, and connect them electrically to the Battery Module Coupling which you fashion from electically conductive materials, and place inside the Battery Module. Fabricate a Vehicle Battery Module Housing so they may mate with the Battery Module Couplings when the Battery Modules are seated by hand into the Vehicle Battery Module Housing.

This system may be used not only by ground transportation vehicles and conveyances but by any powered craft traversing land, sea, air or space so long as it is powered by a power source with definable dimensions.

### BRIEF DESCRIPTION OF THE DRAWINGS

Having thus descibed the invention and it's componants, reference will now be made to the accomanying drawings, which are not necessarily to scale, and wherein:

FIG. 1a-d shows the Battery Module, with FIG. b-d indicating size dimensions.

FIG. 2a-d shows a transparency of the Battery Module in which one example of batteries has been loaded into the Battery Module.

FIG. 3 is a perspective line drawing fo the Battery Module.

FIG. 4 is a perspective line drawing of the Battery Module partially opened to display one example of batteries loaded inside, as well as displaying the Battery Module Coupling.

FIG. 5 is a perspective drawing of the Vehicle Battery Module Housing with Battery Modules loaded into some of it's cavities, and containing a cutaway partial transparency illustrating the Vehicle Receiving Couplings.

FIG. 6 is a perspective drawing of the Temperature-Controlled Exterior Charger with no Battery Modules loaded into it.

FIG. 7 is a diagram of the inside of the Temperature-Controlled Exterior Charger in which Battery Modules have been loaded into it.

FIG. 8 is a transparent line drawing of a sample passenger vehicle in which Battery Module Housings loaded with Battery Modules have been incorporated.

### DETAILED DESCRIPTION OF THE INVENTION

The present inventions now will be described more fully hereafter with reference to the accompanying drawings, in which some examples of the embodiments of the inventions are shown. Indeed, these inventions may be embodied in many different forms and should not be construed as limited to the embodiment set forth herein; rather, these embodiments are provided by way of examples so that this disclosure will satisfy applicable legal requirements.

Like numbers refer to like elements throughout.

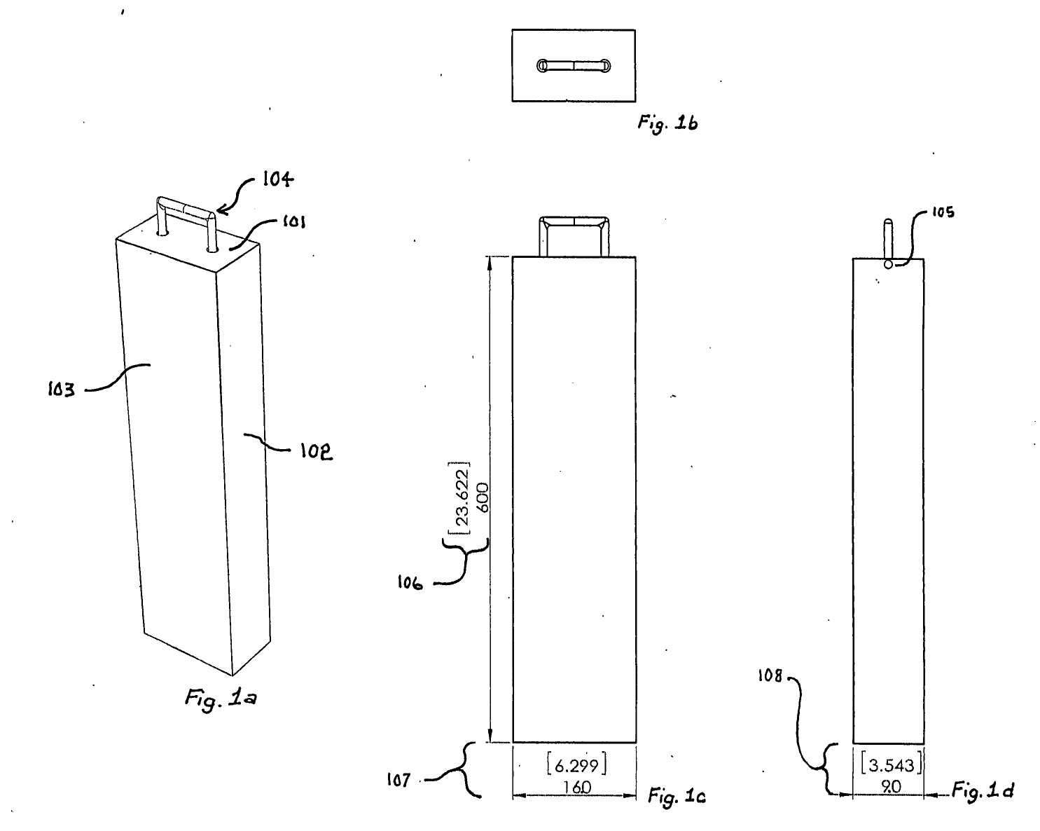

FIG. 1 Illustrates the Battery Module, a six-sided container with a handle. FIG. 1a is a perspective drawing of the Battery Module, displaying the top 101, narrow side 102, wide side 103, and handle 104. FIG. 1b is a line drawing view from the top of the Battery Module. FIG. 1c is a line drawing of the wide side, and features its length measurement to be 60 cm [23.622 inches] 106, and features width measurement to be 16 cm [6.299 inches] 107. FIG. 1d is a line drawing of the narrow side, and features an internal anchor of the handle 105, and also features a measurement of the width of the narrow side as 9 cm [3.543 inches].

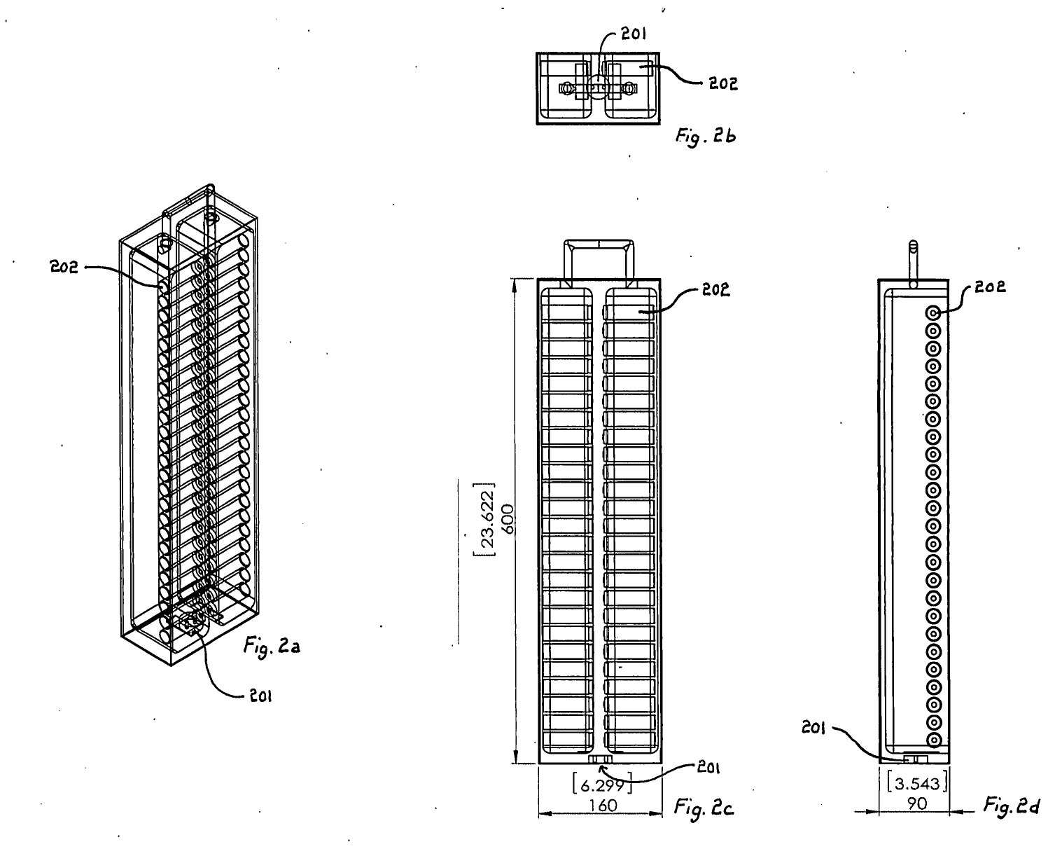

FIG. 2 is a transparent line drawing of the Battery Module revealing it loaded with one kind of battery, with two hundred such batteries loaded into it. FIG. 2a is a perspective line drawing featuring a Battery Module Coupling 201 at the bottom of the Battery Module, and a representative single row of sample batteries displayed with one of them labeled 202. FIG. 2b is a transparent line drawing from the top and features a female Battery Module Coupling 201 and one sample battery 202. FIG. 2c is a transparent line drawing of from the wide side and features the female Battery Module Coupling 201 and labels one sample battery in two sample rows of identical batteries. Although the sample batteries are not identified by type or individual weight their combined, total weight plus that of the Battery Module without them adds up to a total weight of the fully loaded Battery Module at less than 26 pounds.

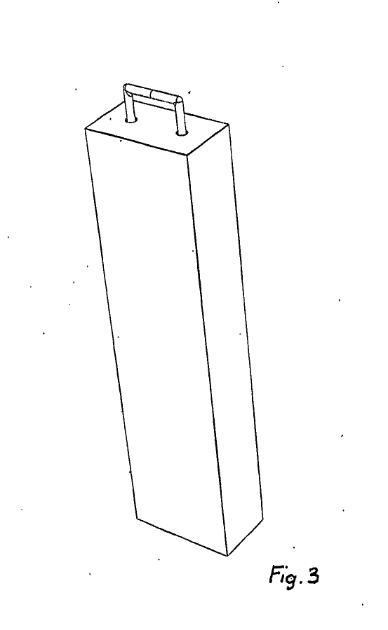

FIG. 3 is a perspective line drawing of the Battery Module.

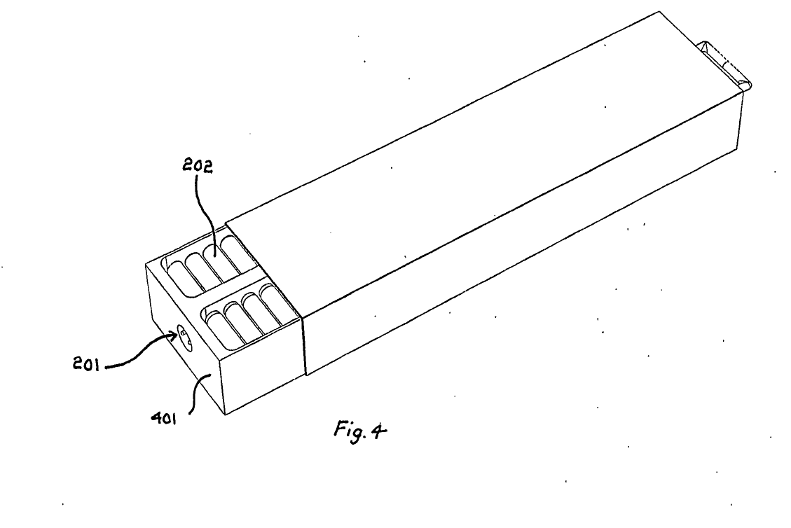

FIG. 4 is a perspective line drawing of the Battery Module opened to partially reveal it loadd with the same type of sample battery 202, and featuring a female Battery Module Coupling 201. This particular Battery Module is constructed with an internal body 401 which contains the sample individual batteries.

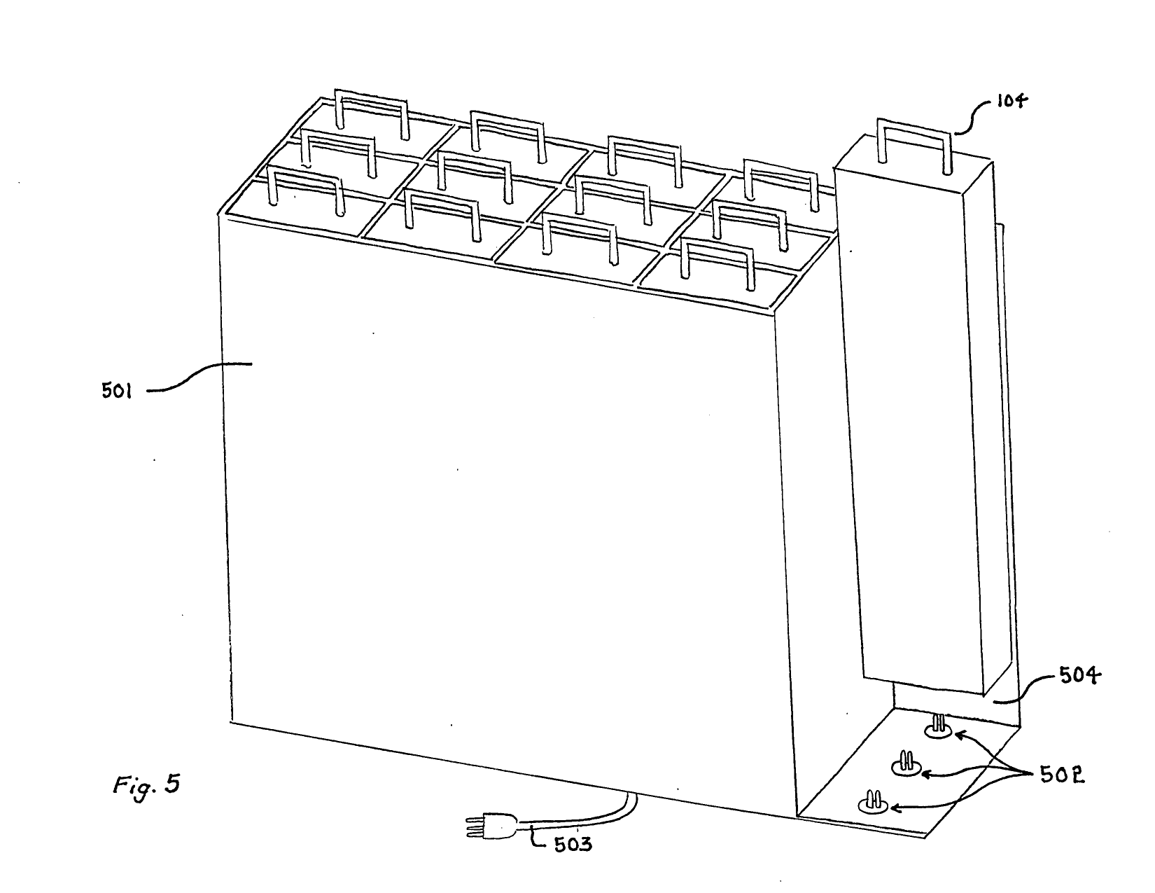

FIG. 5 is a perpective shaded drawing with partial or cutaway transparency of the Vehicle Battery Module Housing, which houses the Battery Modules into the vehicle and conveys their electrical or other power to the drive mechanisms of the vehicle by means of Vehicle Receiving Couplings. The body of the Vehicle Battery Module Housing 501 is strong and rigid and contains one or more [usually many] cavities 504 into which are seated Battery Modules with their handles 104. Within the transparent cutaway is featured two-pin Vehicle Receiving Couplings 502. From the bottom of the Vehicle Battery Module Housing a power cord 503 displayed and is the mechanism of transfer of power from the batteries through the Couplings to the drive mechanism of the vehicle.

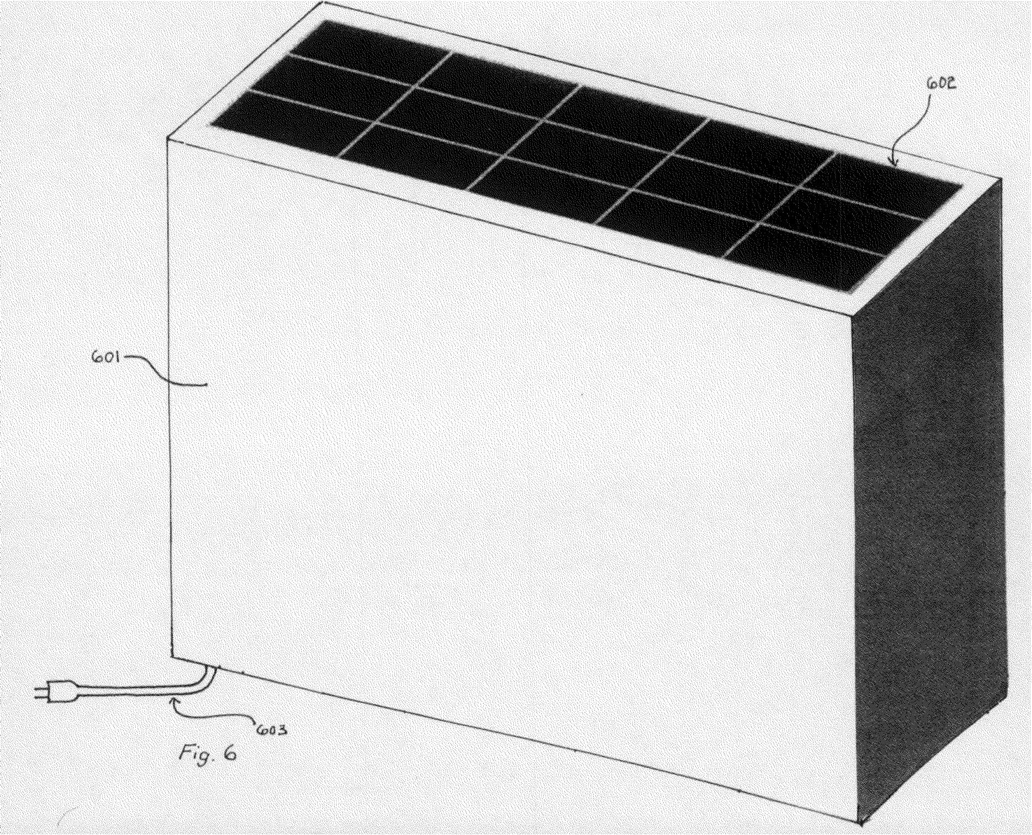

FIG. 6 is a line perspective shaded drawing of the Temperature-Controlled External Battery Charger, with it's body 601, cavities for receiving and seating Battery Modules 602, and emerging from underneath a cord into which it may be connected to receive electrical current 603.

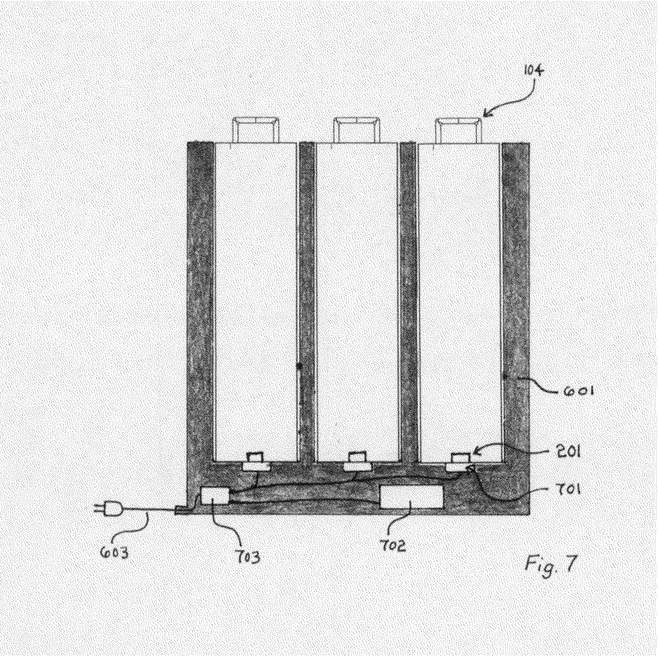

FIG. 7 is a schematic internal diagram of the Temperature-Controlled External Battery Charger into which three Battery Modules with their handles 104 have been seated into cavities for charging. The Temperature-Controlled External Battery Charger body 601 [shaded] posssessed an ability to distribute cooling to the Battery Modules by means of chilling originating from a chilling device 702. In this model the chilling device is powered from an electrical unit which receives current from an outside power source via a chord 603 and also distributes a charging current to the batteries via couplings 701 which mate with the Battery Module Coupling 201.

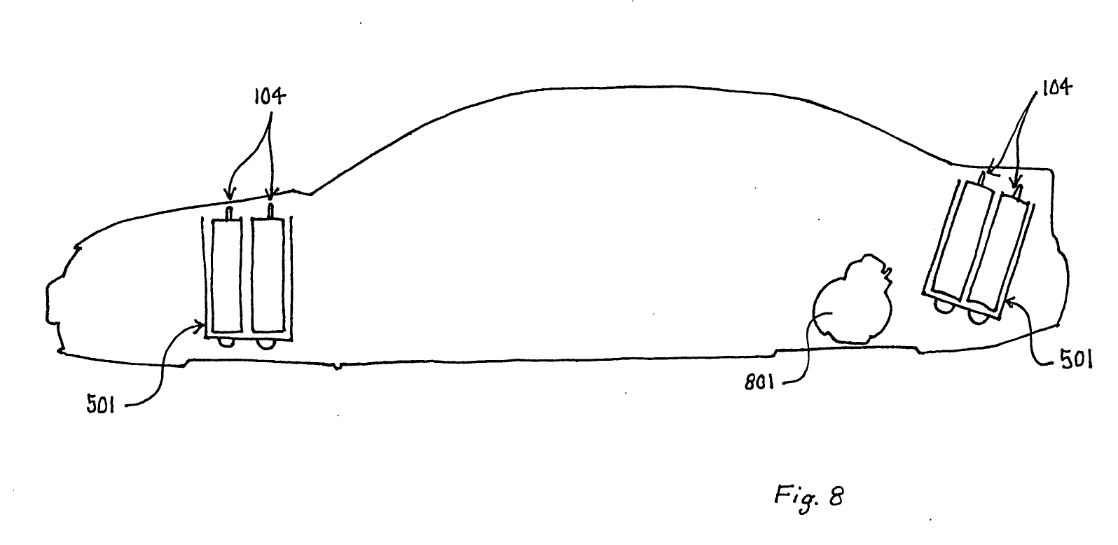

FIG. 8 is a transparent line drawing of a sample representative vehicle, a passenger automobile, in which Vehicle Battery Module Housings have been fitted 501 and into which have seated Battery Modules with their handles 104. Featured as well is the location of a drive motor for the vehicle.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific examples of the embodiments disclosed and that modifications and other embodiments are intended to be included within the scope of the appended claims. Although specific terms are employed herein, they are used in a generic and descriptive sense only and not for the purpose of limitation.

1. This invention permits all-electric vehicles to avoid battery degradation due to charging-induced heat.
Current designs of electric vehicles either have batteries which cannot be removed, or if they are removable and place in an external battery charger the charger is not temperature-controlled or cooled. Either way, the batteries are usually charged without cooling, and the heat resulting from the charging process can degrade the batteries and reduces their working life. Ruin and replacement of batteries due to charging induced heat adds an additional, burdonsom cost of operation. This invention contains an External Battery Charger which contains a cavity into which batteries enclosed in hand-changable Battery Modules are placed. The External Battery Charger is a cooling body, possessing a refrigeration capacity, and maintains the charging batteries contained within the Battery Module at a temperature cool enough so that the batteries are not significantly degraded by charging-induced heat.

2. This invention permits all-electric vehicles to operate for very long durations, allowing for fleets of vehicles using a charging base to enjoy operating durations comparable to fuel-burning internal combustion engine-powered vehicles.
This invention contains hand-changable Battery Modules which contain the individual batteries which are the power source of the vehicle. Because the Battery Modules are light enough and small enough to be removed from the vehicle and replaced, thus allowing newly charged batteries to be quickly installed. Because the Battery Modules are changable by hand, there is no need for the use of expensive robots otherwise needed by larger and heavier changable battery systems.
Any vehicle equiped with this invention may be operated for a distance, and resulting duration, permitted by that vehicle's batteries until they are nearly depleated of their charge. Then by returning to a base where the Temperature-Controlled Battery Charger is located, the vehicle's batteries may be switched with newly-charged ones in a brief procedure comparable to the time involved with fueling a fuel-powered combustion engine. Once the batteries are replaced with charged ones the vehicle is available to be operated for an additional distance and consequent duration. In this way a single vehicle continually changing two sets of batteries contained in the hand-changable Battery Modules can be operated for an indefinite duration bounded only by the life of the batteries and other long-term reliability factors of the vehicle and it's power systems.

3. This invention allows for all electric vehicle operators to enjoy very long ranges of their vehicles because they can change their vehicle's batteries at dispersed vendor locations from where batteries may be leased.
Current battery systems for all-electric vehicles have limited ranges and durations of operation because the vehicles must stop operation while they are tethered to an external charger, or have their batteries changed by robots in stations which are so expensive to create that no one has been able to provide them.
This invention however possesses batteries in hand-changable Battery Modules which permit a vehicle to be operated immediately after a brief changing procedure whereby an able-bodied person removes the Battery Modules containing fully-charged batteries. Because this procedure can be accomplished without the use of expensive robots, any facility or vendor with space available to house banks of Temperature-Controlled Battery Chargers may provide newly-charged Battery Modules to the public. Battery Modules offered will vary, vehicle operators will require that they not purchase batteries but lease them only for the duration of their charged use.

4. Because the size and dimensions of the Battery Modules may be standardized, any vehicle of any manufacture may use Battery Modules manufactured or leased by any company choosing to use a standardized size.
By this means it will be possible at affordable cost for existing stations of vendors selling fuels to combustion engine powered vehicles to also possess Temperature-Controlled Battery Chargers with standardized Battery Modules available for lease to vehicle operators requiring newly charged batteries.

5. This invention operates with the following componants with or without standardized size or weight of the Battery Module. Those componants are the Battery Module, an External Battery Chargerwhich may or may not be temperature controlled, a Vehicle Battery Module Housing into which the Battery Modules are seated into the vehicle, and electric couplings connecting the vehicle's drive source to the batteries within the Battery Modules, identified herein as the Battery Module Coupling and the Vehicle Receiving Coupling. A Vehicle Battery Module Housing is a frame or body inside the vehicle in which the Battery Modules are placed so the Battery Module Coupling and the Vehicle Receiving Coupling may mate.
To make possible the powering of a vehicle by means of batteries contained within a Battery Module, a Battery Module Coupling is located in the Battery Module, and is the nexus of the electrical poles of the batteries so that a circut may be made with them to the vehicle. The Battery Module Coupling may be a male or female electrical coupling which connects the batteries of the Battery Module's circut to the vehicle power system via a Vehicle Receiving Coupling. To make possible the electrical power connection of the vehicle's drive source to the batteries within the Battery Module the Battery Module Housing in the vehicle contains Vehicle Receiving Couplings which mate with the Battery Module Couplings. A Vehicle Receiving Coupling may be a male or female coupling.
